(19) United States
(12) Patent Application Publication
(10) Pub. No.: US 2026/0304309 A1
(43) Pub. Date: Oct. 1, 2026

(54) WIRELESS COMMUNICATION SYSTEM, WIRELESS COMMUNICATION METHOD AND WIRELESS COMMUNICATION CONTROL DEVICE

(71) Applicant: NTT, Inc., Tokyo (JP)

(72) Inventors: Masashi IWABUCHI, Musashino-shi, Tokyo (JP); Riku OMIYA, Musashino-shi, Tokyo (JP); Takumi YONEDA, Musashino-shi, Tokyo (JP); Tomoaki OGAWA, Musashino-shi, Tokyo (JP); Yasushi TAKATORI, Musashino-shi, Tokyo (JP)

(21) Appl. No.: 18/992,632

(22) PCT Filed: Jul. 26, 2022
(86) PCT No.: PCT/JP2022/028729

§ 371 Date: Jan. 9, 2025

(51) Int. Cl. H04W 52/02; H04B 7/04; H04W 16/26

(52) U.S. Cl. CPC H04W 52/0203; H04B 7/04013; H04W 16/26

(57) ABSTRACT

This disclosure relates to a wireless communication system, a wireless communication method, and a wireless communication control device. This wireless communication system is a radio communication system including a base station, an RIS device that reflects a radio wave from the base station to a terminal device, and a control device that controls the RIS device. The control device is configured to pre-estimate radio quality in an area, receive positioning information from a terminal device, perform wake-up determination for determining necessity of activation of the RIS device, and activate a wake-up signal giving an instruction on the activation and an RIS parameter signal in a case of determining that the activation is necessary. The RIS device is configured to, in a case of receiving the wake-up signal, activate the RIS device and perform reflection control of a radio wave in a reflection unit of the RIS device.

### TECHNICAL FIELD

The present disclosure relates to a wireless communication system, a wireless communication method, and a wireless communication control device.

### BACKGROUND ART

Radio waves in a millimeter wave band used in a 5G service and radio waves in a higher frequency band that are being developed for a 6G service have high straightness. Therefore, utilization of a reconfigurable intelligent surface (RIS) technology is expected as a means for improving communication failure due to a shielding object (Non Patent Literatures 1 to 3). In the RIS technology, the radio waves are reflected in a specific direction by arranging elements for electrically switching a phase on a surface of a reflector.

### CITATION LIST

### Non Patent Literature

Non Patent Literature 1: Using Any Surface to Realize a New Paradigm for Wireless Communications (Communications of the ACM, Volume 61, Issue 11, November 2018, p 30-33)

Non Patent Literature 2: Wireless Communications Through Reconfigurable Intelligent Surfaces (IEEE Access, Volume 7, 13 Aug. 2019, p 116753-116773)

Non Patent Literature 3: Intelligent Reflecting Surface Enhanced Wireless Network via Joint Active and Passive Beamforming (IEEE Transactions on Wireless Communications, Volume 18, Issue 11, November 2019, p 5394-5409)

### SUMMARY OF INVENTION

### Technical Problem

In an RIS device, a reflection direction is electrically controlled, and thus power consumption increases. Therefore, in a case of being connected to energy harvesting such as solar power generation, there is a limit to an amount of power generation, and thus there is a problem that full-time operation of the RIS device is difficult. Meanwhile, in a case of being connected to an external power supply, power supply can be sufficiently performed, but there is a problem that an installation place is limited.

To solve the above-described problems, the first object of the present disclosure is to provide a wireless communication system capable of reducing power consumption by reducing an operation frequency of an RIS device.

In addition, the second object of the present disclosure is to provide a wireless communication method capable of reducing the power consumption by reducing the operation frequency of the RIS device.

Moreover, the third object of the present disclosure is to provide a wireless communication control device capable of reducing the power consumption by reducing the operation frequency of the RIS device.

### Solution to Problem

The first aspect of the present disclosure is a wireless communication system including: a base station; an RIS device that reflects a radio wave from the base station to a terminal device; and a control device that controls the RIS device, and is favorably a wireless communication system in which the control device is configured to execute processing of pre-estimating radio quality in an area, processing of receiving positioning information from the terminal device, processing of performing wake-up determination for determining necessity of activation of the RIS device, and activation processing of transmitting a wake-up signal giving an instruction on activation and an RIS parameter signal to the RIS device in a case of determining that the activation is necessary, and the RIS device is configured to execute processing of activating the RIS device in a case of receiving the wake-up signal, and processing of performing reflection control of a radio wave in a reflection unit of the RIS device on a basis of the RIS parameter signal.

The second aspect of the present disclosure is a wireless communication method performed by a wireless communication system including a base station, an RIS device that reflects a radio wave from the base station to a terminal device, and a control device that controls the RIS device, and is favorably a wireless communication method including: processing of pre-estimating radio quality in an area; processing of receiving positioning information from the terminal device; processing of performing wake-up determination for determining necessity of activation of the RIS device; processing of transmitting a wake-up signal giving an instruction on activation and an RIS parameter signal to the RIS device in a case of determining that the activation is necessary; processing of activating the RIS device in a case of receiving the wake-up signal; and processing of performing reflection control of a radio wave in a reflection unit of the RIS device on a basis of the RIS parameter signal.

The third aspect of the present disclosure is favorably a wireless communication control device configured to execute: processing of pre-estimating radio quality in an area; processing of receiving positioning information from a terminal device; processing of performing wake-up determination for determining necessity of activation of the RIS device; and processing of transmitting a wake-up signal giving an instruction on the activation and an RIS parameter signal to the RIS device in a case of determining that the activation is necessary.

### Advantageous Effects of Invention

According to the first, second, and third aspects of the present disclosure, it is possible to reduce the power consumption by reducing the operation frequency of the RIS device.

### BRIEF DESCRIPTION OF DRAWINGS

FIG. 1 is a diagram illustrating a simulation result of radio quality in a case where an RIS device is not used.

FIG. 2 is a diagram illustrating a simulation result of radio quality in a case where a reflection angle of the RIS device is set to 30 degrees.

FIG. 3 is a diagram illustrating a simulation result of radio quality in a case where the reflection angle of the RIS device is set to 60 degrees.

FIG. 4 is a diagram illustrating a configuration of a conventional RIS device.

FIG. 5 is a diagram illustrating a configuration of an RIS device according to a first embodiment of the present disclosure.

FIG. 6 is a diagram illustrating a configuration of a wireless communication system according to the first embodiment of the present disclosure.

FIG. 7 is a chart illustrating an activation procedure of the RIS device according to the first embodiment of the present disclosure.

FIG. 8 is a flowchart illustrating processing of wake-up determination according to the first embodiment of the present disclosure.

### DESCRIPTION OF EMBODIMENTS

### First Embodiment

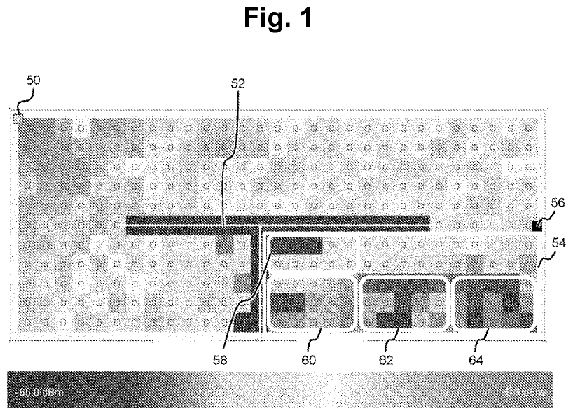

FIG. 1 is a diagram illustrating a simulation result of radio quality in a case where an RIS device is not used. Here, a state in which a simulation result of the radio quality in a case where a shielding object is present in a certain area is viewed from above is illustrated. This area has spots divided into squares. Then, the radio quality is simulated for each spot, and the result of the simulation is indicated by a color change.

A base station 50 is installed on upper left of the area. A shielding object 52 is installed near a center of the area. A radio wave transmitted from the base station 50 is shielded by the shielding object 52. Therefore, the radio quality is deteriorated in an area 54. Hereinafter, a spot where the radio quality is deteriorated is referred to as a dead spot.

Here, an RIS device 56 is installed at a position of FIG. 1. The RIS device 56 can control a reflection direction of the radio wave, thereby improving the radio quality. For example, the radio quality can be improved in an area 58 with a reflection angle of 0 degrees, an area 60 with the reflection angle of 20 degrees, an area 62 with the reflection angle of 30 degrees, and an area 64 with the reflection angle of 60 degrees.

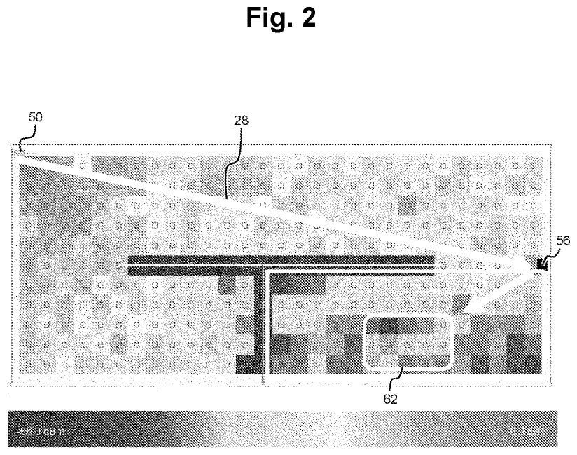

FIG. 2 is a diagram illustrating a simulation result of the radio quality in a case where the reflection angle of the RIS device is set to 30 degrees. That is, a simulation result in a case where the RIS device 56 reflects a radio wave 28 transmitted from the base station 50 at the reflection angle of 30 degrees is illustrated. At this time, it can be seen that the radio quality of the area 62 is improved.

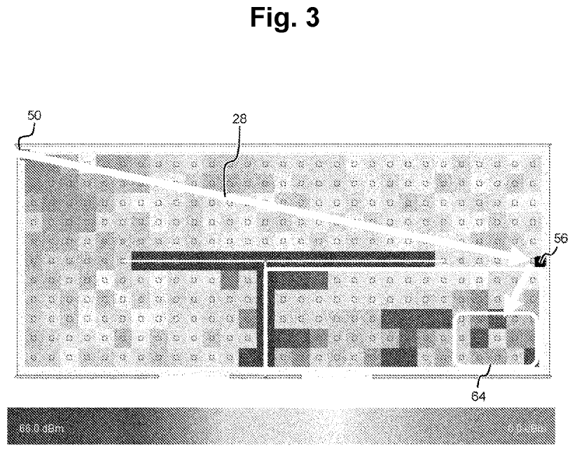

FIG. 3 is a diagram illustrating a simulation result of radio quality in a case where the reflection angle of the RIS device is set to 60 degrees. That is, a simulation result in a case where the RIS device 56 reflects the radio wave 28 transmitted from the base station 50 at the reflection angle of 60 degrees is illustrated. At this time, it can be seen that the radio quality of the area 64 is improved.

As described above, in the case where the radio quality is improved in the areas of FIG. 1, reflection control by the RIS device is effective only in the area 54. That is, in a case of compensating for the dead spot of the area, it is sufficient that the RIS device is activated when a terminal device is located in the dead spot, and it is not necessary to always activate the RIS device.

Therefore, in the present disclosure, coordinate information of the dead spot and an RIS parameter for compensating for the dead spot are pre-estimated by simulation. Then, only when a user having the terminal approaches the dead spot, the RIS device is activated.

Thereafter, the reflection control of the radio wave is performed using the RIS parameter corresponding to the dead spot. As a result, since the RIS device can be maintained in a sleep state when activation is unnecessary, power consumption can be reduced.

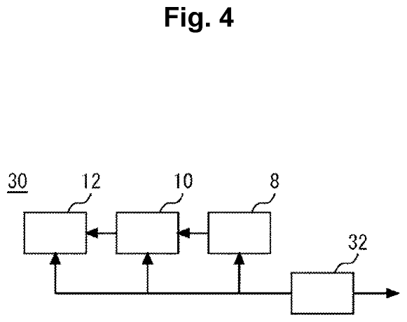

FIG. 4 is a diagram illustrating a configuration of a conventional RIS device. A conventional RIS device 30 includes a communication unit 8. The communication unit 8 receives necessary information from an outside. Examples of the necessary information include information of a phase change amount calculated externally and information necessary for calculating the phase change amount. Then, the information is transmitted to a control unit 10.

The control unit 10 determines the phase change amount in a reflection unit 12 to be described below on the basis of the information obtained from communication unit 8. Then, the phase change amount is transmitted to the reflection unit 12.

The reflection unit 12 reflects the radio wave by a plurality of elements provided on a surface of a reflector. A change amount in phase used to reflect the radio wave by each element is adjusted by the control unit 10. Thus, a reflection characteristic of the radio wave can be dynamically switched.

A power supply unit 32 supplies power supplied from an external power supply to the communication unit 8, the control unit 10, and the reflection unit 12.

As described above, the power supply is necessary for the reflection direction control of the radio wave by the RIS device. In a case where the RIS device operates at all times, the power consumption increases because many functional units require electricity. In a case where the reflection unit 12 is enlarged using a large number of elements or in a case where a large number of RIS devices is installed, the total power consumption further increases. For this reason, it is necessary to be connected to the external power supply by wire, and there is a problem that an installation place of the RIS device is limited.

Even if the RIS device is connected to environmental power generation such as solar power generation, a power generation amount of the energy harvesting is limited. That is, it is difficult to operate the RIS device at all times, and there is a problem of a high possibility that the RIS device cannot function at necessary timing. The present disclosure solves the above-described problem.

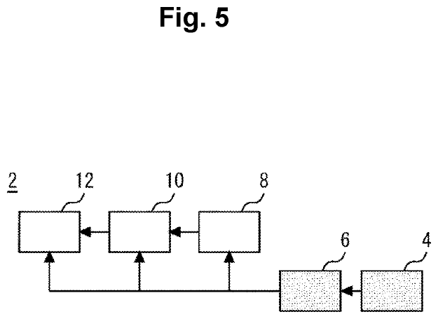

FIG. 5 is a diagram illustrating a configuration of the RIS device according to the first embodiment of the present disclosure. An RIS device 2 according to the first embodiment is different from the conventional RIS device in using energy harvesting instead of an external power supply.

The RIS device 2 includes a communication unit 8, a control unit 10, and a reflection unit 12. The communication unit 8, the control unit 10, and the reflection unit 12 have the same functions as those of the RIS device 30. Further, the RIS device includes a power generation unit 4. To secure power necessary for driving the RIS device 2, the power generation unit 4 generates power and sends the obtained power to a power feed unit 6. The power feed unit 6 sends the obtained power to the communication unit 8, the control unit 10, and the reflection unit 12. As a result, the RIS device can be driven without being connected to the external power supply.

The power that can be supplied from the power generation unit 4 is smaller than that of the external power supply. However, in the present disclosure, a drive time of the RIS device 2 is suppressed by power supply control. More specifically, the RIS device 2 is caused to function only at timing required by the user. As a result, since the power consumption can be reduced, communication quality of the user can be improved even in the configuration of the RIS device 2.

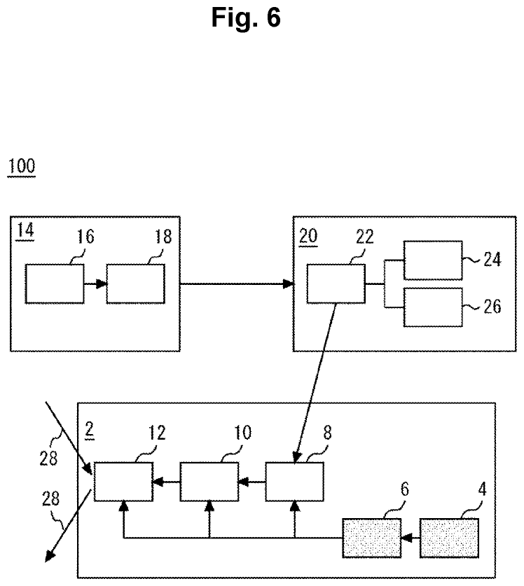

FIG. 6 is a diagram illustrating a configuration of a wireless communication system according to the first embodiment of the present disclosure. A wireless communication system 100 includes a terminal device 14. The terminal device 14 is a user terminal that performs wireless communication with the base station, and includes a sensor unit 16. The sensor unit 16 detects positioning information of the terminal device 14 and transmits the positioning information to a communication unit 18. The communication unit 18 transmits the positioning information to a control device 20.

Note that the terminal device 14 may be a fixedly installed sensor terminal instead of the user terminal. In this case, what is transmitted to the control device 20 is not the positioning information of the sensor terminal itself but sensor information of the user terminal detected by the sensor terminal.

The control device 20 includes a communication unit 22. The communication unit 22 receives the positioning information transmitted from the terminal device 14.

Furthermore, the control device 20 includes a pre-estimation unit 24. The pre-estimation unit 24 performs pre-estimation of the dead spot and the like. For this pre-estimation, a simulation may be used or a site survey result may be used. Then, a pre-estimation result is transmitted to an RIS control unit 26.

Further, the control device 20 includes an RIS control unit 26. The RIS control unit 26 manages wake-up determination to be described below using the pre-estimation result. As a result of the determination, in a case where necessity of driving of the RIS occurs, necessary information is transmitted to the communication unit 22. Examples of the necessary information include information of a phase change amount calculated externally and information necessary for calculating the phase change amount. The communication unit 22 transmits the information transmitted from the terminal device, the pre-estimation unit 24, and the RIS control unit 26 to the RIS device 2.

Note that the control device 20 of the present disclosure can also be realized by a computer and a program. Further, the control device 20 can record the program in a recording medium or can provide the program through a network.

The RIS device 2 receives the information transmitted from the communication unit 22 by the communication unit 8. The control unit 10 determines the phase change amount of the reflection unit 12 on the basis of the information. The reflection unit 12 reflects a radio wave 28 with the determined phase change amount.

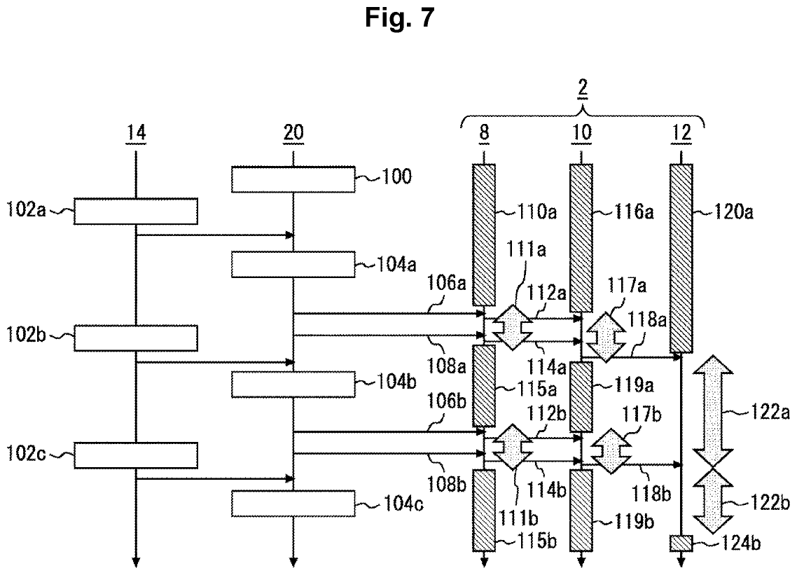

FIG. 7 is a chart illustrating an activation procedure of the RIS device according to the first embodiment of the present disclosure. First, the control device 20 performs pre-estimation 100. Here, as described above, the dead spot and the RIS parameter for compensating for the dead spot are pre-estimated by simulation. This simulation may be performed for the entire area supported by the wireless communication system 100, or may be performed only for an area desired to be supported by the RIS device 2.

Next, the terminal device 14 performs positioning 102a. That is, the sensor unit 16 included in the terminal device 14 acquires the positioning information of the terminal device 14. Then, the positioning information is transmitted to the control device 20. The positioning information may be periodically transmitted at an arbitrary cycle such as a cycle of 100 ms or a cycle of 1 second.

Alternatively, the transmission may be performed irregularly at request timing of the terminal device 14 itself. Examples of the request timing include a case where the communication quality becomes an arbitrary value or less, and a case where high communication quality is desired to be requested.

Next, the control device 20 performs wake-up determination 104a. This is a determination for activating the RIS device 2 when the user approaches the dead spot. Details of the wake-up determination will be described below.

In a case where determination to activate the RIS device 2 is made, the control device 20 transmits a wake-up signal 106a and an RIS parameter signal 108a to the communication unit 8. The RIS parameter signal 108a includes, for example, a phase coefficient and an active time. The active time indicates a time for which each device is maintained in an active state.

When having received the wake-up signal 106a, the communication unit 8 changes a status from a sleep state 110a to an active state 111a. The communication unit 8 is normally in the sleep state, but can receive a signal from the control device 20 because the status is changed to the active state periodically or at specified timing. Then, the communication unit 8 transmits an activation signal 112a and an RIS parameter 114a to the control unit 10.

When having transmitted the RIS parameter 114a, the communication unit 8 changes the status from the active state 111a to a sleep state 115a. Accordingly, the power consumption can be reduced.

When having received the activation signal 112a, the control unit 10 changes the status from a sleep state 116a to the active state 117a. Then, the control unit 10 transmits an RIS setting 118a to the reflection unit 12.

When having transmitted the RIS setting 118a, the control unit 10 changes the status from the active state 117a to a sleep state 119a. Accordingly, the power consumption can be reduced.

When having received the RIS setting 118a, the reflection unit 12 changes the status from a sleep state 120a to an active state 122a. Then, the reflection unit 12 performs reflection control for the radio wave using RIS setting 118a.

A case where the active time of the reflection unit 12 is extended will be described. In FIG. 7, the terminal device 14 performs next positioning 102b after a certain time from the positioning 102a. Accordingly, the control device 20 and the RIS device 2 repeat the above-described processing.

However, here, the operation of the reflection unit 12 is different from the above-described processing. If a next RIS setting is not received during the active time, the reflection unit 12 changes the status from the active state to the sleep state. However, the timing when the reflection unit 12 receives a next RIS setting 118b is in the middle of the active state 122a. Therefore, the active time is extended by shifting from the active state 122a to an active state 122b. Thereafter, since the next RIS setting is not received during the active state 122b, the status is changed to a sleep state 124b.

A case where the RIS device 2 is not activated as a result of the wake-up determination will be described. In FIG. 7, the terminal device 14 performs next positioning 102c after a certain time from the positioning 102b.

Accordingly, the control device 20 performs wake-up determination 104c. As a result, since determination not to activate the RIS device 2 is made, the wake-up signal and the like are not transmitted thereafter.

Note that the communication unit 8, the control unit 10, and the reflection unit 12 perform intermittent operations while maintaining the sleep state. As a result, since signals can be periodically received, each signal can be received while maintaining the sleep state.

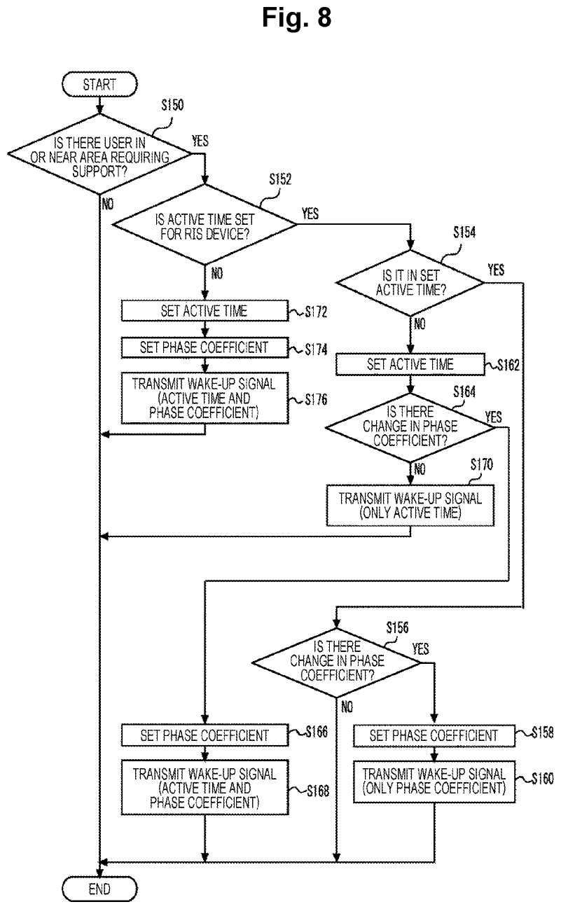

FIG. 8 is a flowchart illustrating processing of wake-up determination according to the first embodiment of the present disclosure. First, in step 150, it is checked whether there is the user in or near the area requiring support. That is, it is checked whether the user is around the dead spot.

Specifically, the positioning information transmitted from the terminal device is collated with the coordinate information of the dead spot simulated by the pre-estimation. In the case where the fixedly installed sensor terminal is used, the positioning information estimated from the sensor information is used. In the case where the user is around the dead spot, the processing proceeds to step 152. In the case where the user is not around the dead spot, it is determined that activation processing for the RIS device 2 is unnecessary, and the processing is terminated.

In step 152, it is checked whether the active time is set for the RIS device 2. In the case where the active time is set, the processing proceeds to step 154. In the case where the active time is not set, the processing proceeds to step 166.

In step 154, it is checked whether the RIS device 2 is in the set active time. In the case where it is in the active time, the processing proceeds to step 156. In the case where it is not in the active time, the processing proceeds to step 162.

In step 156, it is checked whether there is a change in the phase coefficient. In the case where there is a change, the processing proceeds to step 158. In the case where there is no change, it is determined that activation processing for the RIS device 2 is unnecessary, and the processing is terminated. That is, it is possible to prevent wasteful consumption of power due to further performing the activation processing for the RIS device 2 being activated.

In step 158, the phase coefficient is set, and the processing proceeds to step 160. In step 160, the wake-up signal is transmitted, and the processing is terminated.

The wake-up signal includes information of the phase coefficient.

In step 162, the active time is set. Any value may be set as the active time. When the setting is completed, the processing proceeds to step 164.

In step 164, it is checked whether there is a change in the phase coefficient. In the case where there is a change, the processing proceeds to step 166. In the case where there is no change, the processing proceeds to step 170.

In step 166, the phase coefficient is set, and the processing proceeds to step 168. In step 168, the wake-up signal is transmitted, and the processing is terminated.

The wake-up signal includes information of the active time and the phase coefficient.

In step 170, the wake-up signal is transmitted, and the processing is terminated. The wake-up signal includes the information of the active time.

In step 172, the active time is set. Any value may be set as the active time. When the setting is completed, the processing proceeds to step 174.

In step 174, the phase coefficient is set, and the processing proceeds to step 176. In step 176, the wake-up signal is transmitted, and the processing is terminated.

The wake-up signal includes information of the active time and the phase coefficient.

As described above, according to the aspect of the present disclosure, the RIS device can be activated only when the user is in the area with poor communication quality. As a result, since the sleep state of the RIS device can be maintained to the maximum, the power consumption of the RIS device can be reduced. Furthermore, the RIS device can be caused to function for a long period of time even in a case where the power supply is smaller than that of an external power supply, such as a case where the power is supplied to the RIS device by energy harvesting.

### Reference Signs List

12 Reflection unit
14 Terminal device
20 Control device
28 Radio wave
50 Base station
100 Wireless communication system

1. A wireless communication system comprising:
a base station;
a reconfigurable intelligent surface (RIS) device configured to reflect a radio wave from the base station to a terminal device; and
a control device configured to control the RIS device, wherein the control device is configured to execute operations comprising:
pre-estimating radio quality in an area,
receiving positioning information from the terminal device,
performing wake-up determination for determining necessity of activation of the RIS device, and
activating transmission of a wake-up signal giving an instruction on activation and an RIS parameter signal to the RIS device in a case of determining that the activation is necessary, and
the RIS device is configured to execute
activating the RIS device in a case of receiving the wake-up signal, and
performing reflection control of a radio wave in a reflection unit of the RIS device on a basis of the RIS parameter signal.

2. The wireless communication system according to claim 1, wherein
the wake-up determination includes
determining that the RIS device needs to be activated when the terminal device is located around a dead spot with low radio quality on a basis of the pre-estimation and the positioning information.

3. The wireless communication system according to claim 1, wherein
the RIS parameter signal includes at least one of an active time that is a time for bringing the RIS device into an active state or a phase coefficient to be used for the reflection control.

4. The wireless communication system according to claim 3, wherein
the activating transmission includes
transmitting the wake-up signal and the RIS parameter signal in a case where the active time is set for the RIS device and the RIS device is not in the active time.

5. The wireless communication system according to claim 1, wherein
the positioning information is at least one of periodically transmitted at an arbitrary cycle or irregularly transmitted at request timing of the terminal device.

6. The wireless communication system according to claim 1, wherein the pre-estimation uses at least one of a simulation or a site survey result.

7. A wireless communication method performed by a wireless communication system including a base station, a reconfigurable intelligent surface (RIS) device that reflects a radio wave from the base station to a terminal device, and a control device that controls the RIS device, the wireless communication method comprising:
pre-estimating radio quality in an area;
receiving positioning information from the terminal device;
performing wake-up determination for determining necessity of activation of the RIS device;
transmitting a wake-up signal giving an instruction on activation and an RIS parameter signal to the RIS device in a case of determining that the activation is necessary;
activating the RIS device in a case of receiving the wake-up signal; and
performing reflection control of a radio wave in a reflection unit of the RIS device on a basis of the RIS parameter signal.

8. A wireless communication control device configured to execute operations comprising:
pre-estimating radio quality in an area;
receiving positioning information from a terminal device that is a reflection destination of a radio wave;
performing wake-up determination for determining necessity of activation of a reconfigurable intelligent surface (RIS) device to be controlled; and
transmitting a wake-up signal giving an instruction on the activation and an RIS parameter signal to the RIS device in a case of determining that the activation is necessary.
